(19) United States
(12) Patent Application Publication
(10) Pub. No.: US 2026/0230165 A1
(43) Pub. Date: Aug. 6, 2026

(54) Enhancements for TCI State Update to Support Multi-TRP Operation

(71) Applicant: Apple Inc., Cupertino, CA (US)

(72) Inventors: Hong HE, San Jose, CA (US); Chunxuan YE, San Diego, CA (US); Dan WU, Beijing (CN); Dawei ZHANG, Saratoga, CA (US); Huaning NIU, San Jose, CA (US); Wei ZENG, Saratoga, CA (US)

(21) Appl. No.: 19/154,952

(22) PCT Filed: Feb. 13, 2023
(86) PCT No.: PCT/CN2023/075668

§ 371 Date: Aug. 8, 2025

(51) Int. Cl. H04B 7/06; H04L 1/00; H04W 72/231; H04W 76/10; H04W 80/02

(52) U.S. Cl. CPC H04B 7/06968; H04L 1/0061; H04W 72/231; H04W 76/10; H04W 80/02

(57) ABSTRACT

A user equipment (UE) is configured to establish a connection to a base station in multi-transmission reception point (mTRP) mode, wherein the UE is configured with a first set of transmission configuration indicator (TCI) states to communicate with the base station, receive a TCI update, the TCI update indicating a second set of TCI states and update the first set of TCI states based on the second set of TCI states indicated by the TCI state update.

### TECHNICAL FIELD

The present disclosure generally relates to wireless communication, and in particular, to enhancements for TCI state update to support multi-TRP operation.

### BACKGROUND

A user equipment (UE) may connect to a network via a base station that controls multiple transmission and reception points (TRPs). In some scenarios, the UE may operate in multi-TRP (mTRP) mode where the UE establishes and maintains a connection with multiple TRPs at the same time. It has been identified that there exists a need for techniques related to handling different combinations of transmission configuration indicator (TCI) states indicated in a TCI state update for mTRP mode.

### SUMMARY

Some exemplary embodiments are related to a method performed by a user equipment (UE). The method includes establishing a connection to a base station in multi-transmission reception point (mTRP) mode, wherein the UE is configured with a first set of transmission configuration indicator (TCI) states to communicate with the base station, receiving a TCI update, the TCI update indicating a second set of TCI states and updating the first set of TCI states based on the second set of TCI states indicated by the TCI state update.

Other exemplary embodiments are related to a user equipment (UE) having a transceiver configured to communicate with a base station and a processor communicatively coupled to the transceiver. The processor is configured to establish a connection to a base station in multi-transmission reception point (mTRP) mode, wherein the UE is configured with a first set of transmission configuration indicator (TCI) states to communicate with the base station, receive a TCI update, the TCI update indicating a second set of TCI states and update the first set of TCI states based on the second set of TCI states indicated by the TCI state update.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for performing a transmission configuration indicator (TCI) state update according to various exemplary embodiments.

FIG. 5a shows a table illustrating an example of different possible combinations of TCI states for unified TCI framework for multi-TRP (mTRP) according to various exemplary embodiments.

FIG. 5b shows an example of TCI state numbering according to various exemplary embodiments.

FIG. 6 shows examples for using the exemplary parameters introduced herein to perform a TCI update according to various exemplary embodiments.

FIG. 7 shows a table for implicit signaling based on control resource set (CORESET) grouping according to various exemplary embodiments.

FIG. 8 shows an example of performing a TCI state update for mTRP according to various exemplary embodiments.

FIG. 9 shows an example of performing a TCI state update for mTRP according to various exemplary embodiments.

### DETAILED DESCRIPTION

The exemplary embodiments may be further understood with reference to the following description and the related appended drawings, wherein like elements are provided with the same reference numerals. The exemplary embodiments relate to beam management and multi-transmission reception point (TRP) operation.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate type of electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The exemplary embodiments are described with regard to multi-TRP (mTRP) operation. From the perspective of the UE, mTRP operation may include establishing and maintaining a connection with multiple TRPs at the same time. For example, different channel state information (CSI)-reference signals (RS) resource sets may be configured for different TRPs to support CSI measurement. In 5G NR, a unified transmission configuration indicator (TCI) framework is intended to facilitate streamlined mTRP operation. It has been identified that there is a need for enhancements to the unified TCI framework that improve support for mTRP operation.

According to some aspects, up to four TCI states may be indicated in a component carrier (CC)/bandwidth part (BWP) or in a set CCs/BWPs. The TCI states may be indicated or updated by a medium access control (MAC) control element (CE)/downlink control information (DCI) with a MAC CE based TCI activation command. There exists a need for techniques related to handling different combinations of joint/downlink (DL)/uplink (UL) TCI states that may be indicated for DL reception and/or UL transmission in a BWP/CC/TRP. In addition, there exists a need for techniques that enable the UE to determine which currently configured TCI states are to be updated by the TCI update when the TCI update is for a number of TCI states that is less than the currently configured number of TCI state. For example, if four TCI states are currently configured and the TCI update is for less than four TCI states, there is a need to define UE behavior such that the UE knows which of the four TCI states are to be updated.

According to other aspects, the exemplary embodiments relate to configuring TCI states for different control resources sets (CORESETs). Different CORSETS may be used for different types of signals. For example, one CORESET may be used for the reception of a system information block (SIB) and another CORESET may be used for unicast data scheduling. There exists a need for techniques that enable the UE to determine which of the indicated TCI states are to be used for a particular CORESET. As will be described in more detail below, the exemplary embodiments include techniques for addressing the types of issues referenced above.

While the exemplary embodiments provide benefits to the 5G NR unified TCI framework, the exemplary embodiments are not limited to the 5G NR unified TCI framework or even a 5G system. The exemplary embodiments may be applied to any appropriate type of wireless communication system. The exemplary embodiments introduced herein may be used independently from one another, in conjunction with other currently implemented mechanisms for mTRP operation, in conjunction with future implementations of mechanisms for mTRP operation or independent from other mechanisms for mTRP operation.

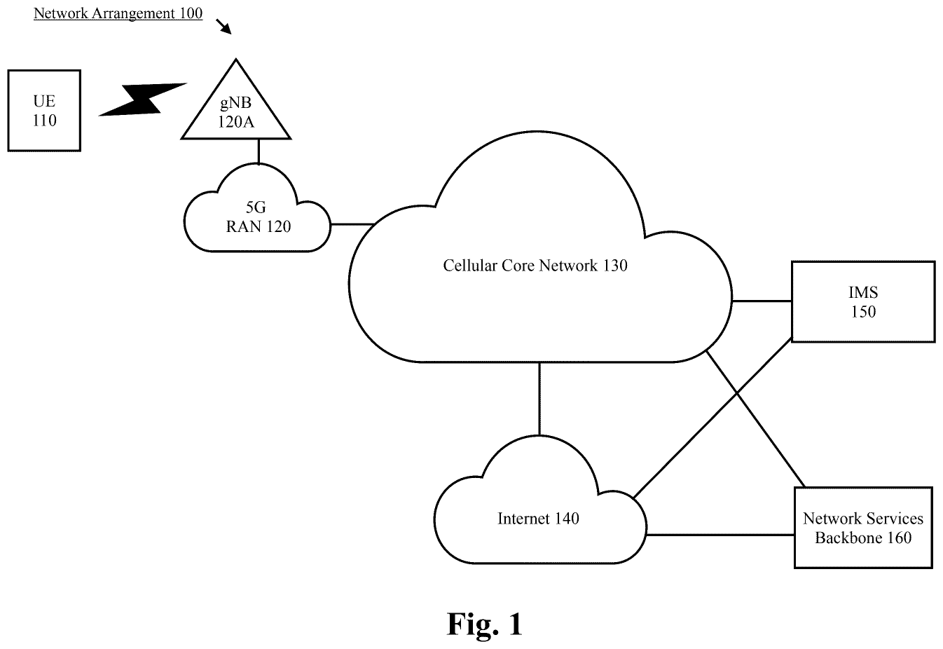

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., sixth generation (6G) RAN, 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

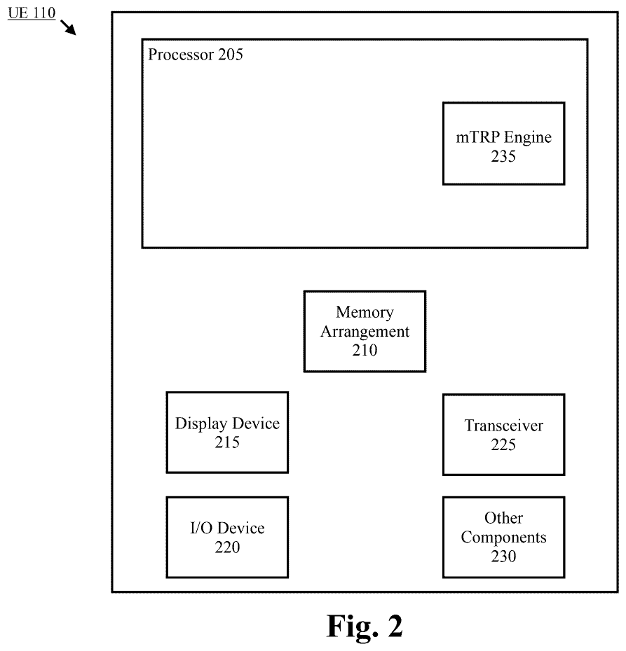

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP engine 235. The mTRP engine 235 may perform various operations related to mTRP operation. To provide some general examples, the mTRP engine 235 may perform operations such as, but not limited to, receiving a TCI state update, determining which one or more TCI states are to be updated and using the updated TCI states for downlink and/or uplink communication.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

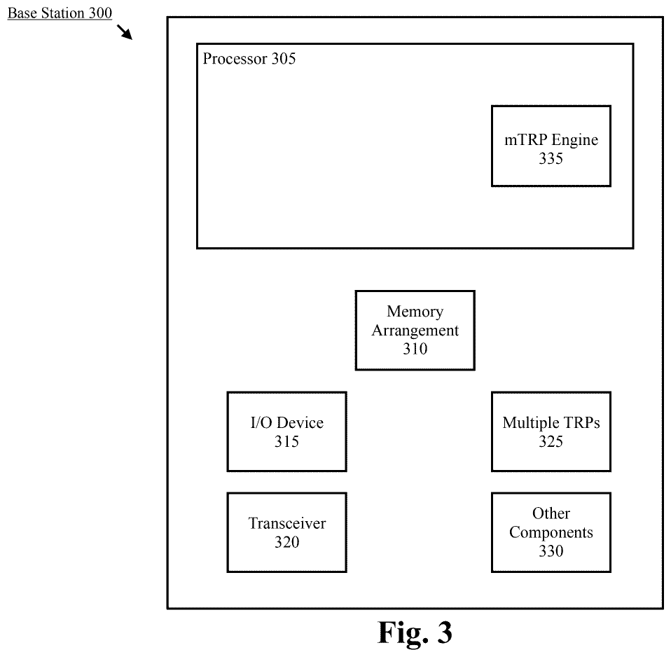

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 330 may include, for example, an audio input device, an audio output device, a battery, a data acquisition device, ports to electrically connect the base station 300 to other electronic devices and/or power sources, TxRUS, transceiver chains, antenna elements, antenna panels, etc.

As indicated above, in some scenarios, the multiple TRPs 325 may be deployed locally at the base station 300. In other scenarios, one or more of the multiple TRPs 325 may be deployed at physical locations remote from the base station 300 and connected to the base station via a backhaul connection. The base station 300 may be configured to control the multiple TRPs 325 and perform operations such as, but not limited to, assigning resources, configuring reference signals, implementing beam management techniques, etc.

The processor 305 may be configured to execute a plurality of engines for the base station 300. For example, the engines may include a mTRP engine 335. The mTRP engine 335 may perform various operations related to mTRP operation. To provide some general examples, the mTRP engine 335 may perform operations such as, but not limited to, transmitting a TCI update to the UE 110 and communicating with the UE 110 using the updated TCI states.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs.

As mentioned above, the exemplary embodiments relate to a unified TCI framework that is configured to facilitate mTRP operation. Those skilled in the art will understand that a TCI state may indicate that a beam is quasi co-located to specific reference signal and define a search space. Thus, the TCI state may indicate the location of one or more search spaces relative to one or more reference signals. During operation, the UE 110 may be configured with multiple TCI states and the network may indicate which of the TCI states are to be used for subsequent communication.

In 5G NR, a unified TCI state may be used for multiple channels simultaneously. The network may configure a common TCI pool and then indicate one or more TCI states from the common TCI pool to be used for subsequent communication. For example, a unified TCI state may be commonly applied to downlink signals, e.g., reference signals, a CORESET, physical downlink shared channel (PDSCH), etc. In another example, a unified TCI state may be commonly applied to uplink signals, e.g., physical uplink shared channel (PUSCH), physical uplink control channel (PUCCH), sounding reference signals (SRS), etc. In another example, a unified TCI state may be commonly applied for multiple UL and DL channels. In this example, there may be a joint TCI state pool for the UL/DL or there may be a separate downlink TCI state pool and UL TCI state pool. The exemplary embodiments may be applied to both the joint TCI state pool mechanisms and the separate UL/DL TCI state pool mechanism.

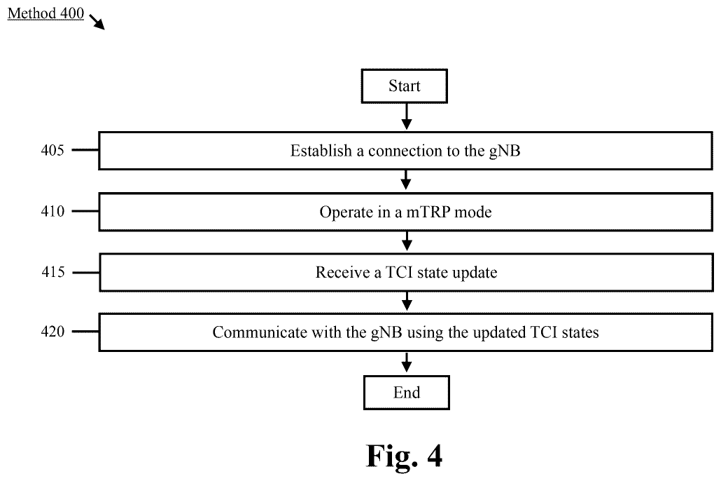

According to some aspects, the exemplary embodiments introduce techniques for performing a TCI state update. FIG. 4 shows a method 400 for performing a TCI state update according to various exemplary embodiments. The method 400 is described from the perspective of the UE 110 and is provided as a general overview of a scenario during which the exemplary techniques introduced herein may be utilized. Additional details regarding the exemplary techniques for TCI state update will be provided below after the description of the method 400.

In 405, the UE 110 establishes a connection to the gNB 120A. To establish the connection, the UE 110 may receive configuration information that enables mTRP operation. For example, the UE 110 may be configured with a joint TCI state pool, a downlink TCI state pool, an uplink TCI state pool and/or any other appropriate type of configuration information to enable communication between the UE 110 and the TRPs of the gNB 120A.

In 410, the UE 110 operates in mTRP mode. In mTRP mode, the UE 110 may be configured to communicate with multiple TRPs of the gNB 120A. To communicate with the gNB 120A, the UE 110 may be configured with one or more TCI states. As mentioned above, according to some aspects, the UE 110 may be configured with up to four TCI states.

In 415, the UE 110 receives a TCI update from the gNB 120A. In 420, the UE 110 communicates with the gNB 120A using the updated TCI states.

According to some aspects, the exemplary embodiments introduce parameters b₀ and b₀b₁ that may be used for indicating a TCI state update. Within the context of the method 400, these parameters may be provided to the UE 110 in 415. Specific details regarding the contents of these parameters, how they may be signaled to the UE 110 and the corresponding UE 110 behavior are provided below.

The exemplary embodiments are described with regard to a TCI codepoint. Those skilled in the art will understand that the term “TCI codepoint” refers to a value that may be included in a TCI field of DCI. Each TCI codepoint may be associated with one or more TCI states based on a MAC CE. For instance, an activation command of the MAC CE may be used to map different combinations of one or more TCI states to the TCI field in the DCI.

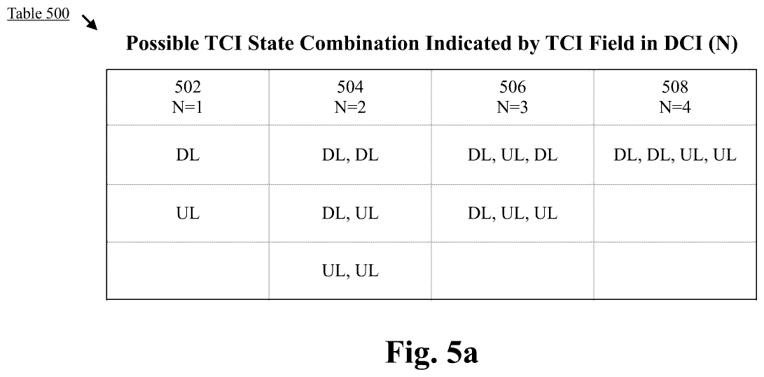

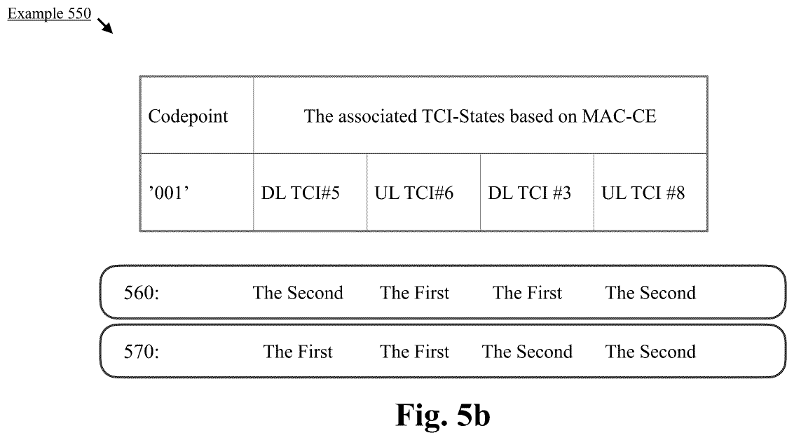

The following exemplary embodiments include techniques for interpreting the indicated TCI states when the number of indicated TCI states is less than a maximum number of TCI states (e.g., 4). FIG. 5a shows a table 500 illustrating an example of different possible combinations of TCI states for a unified TCI framework for mTRP according to various exemplary embodiments.

Each column of the table 500 represents a total number of TCI states indicated by a TCI field in DCI (N). In some embodiments, for a joint TCI mode, there may be two possible TCI states indicated by the TCI field in a DCI since the joint TCI states may be applied to the DL and/or the UL.

In column 502, N=1 and there are two different possible combinations of TCI states. A first set of TCI states comprising one DL TCI state and a second set of TCI states comprising one UL TCI state.

In column 504, N=2 and there are three different possible combinations of TCI states. A first set of TCI states comprising two DL TCI states, a second set of TCI states comprising one DL TCI state and UL TCI state and a third ser of TCI states comprising two UL TCI states.

In column 506, N=3 and there are two different possible combinations of TCI states. A first set of TCI states comprising two DL TCI states and one UL TCI state, a second set of TCI states comprising one DL TCI state and two UL TCI states.

In column 508, N=4 and there is one possible combination of TCI states. A first set of TCI states comprising two DL TCI states and two UL TCI states.

The TCI states associated with a single TCI codebook may be ordered in a variety of different ways. In this context, the order of TCI states may refer an order in which currently configured TCI states are interpreted by the UE 110 (e.g., the first TCI state, the second TCI state, etc.). As will be described in more detail below, the order of TCI states may be considered for determining which TCI state is to be updated using the exemplary parameters b₀ and b₀b₁.

When separate UL/DL TCI mode is configured, a separate numbering operation may be conducted to order the DL TCI states and UL TCI states associated with a same TCI codepoint. In some embodiments, the order of TCI states may be based on a value of the TCI state ID where the first TCI state is associated with a smallest TCI state ID, the second TCI state is associated with the second smallest TCI state ID, etc. In other embodiments, the TCI states associated with a same TCI codepoint may be based on the TCI state index of the MAC CE where the first TCI state is the TCI state associated with a lowest octet index in the MAC CE, the second TCI state is the TCI state associated with the second lowest octet index, etc.

FIG. 5 b shows an example 550 of TCI state numbering according to various exemplary embodiments. In this non-limiting example, it is assumed that there are separate DL/UL TCI states and thus, a separate numbering operation may be conducted to order the DL TCI states and UL TCI states associated with a same TCI codepoint.

Example 550 shows that TCI codepoint 001 is associated with the following TCI state IDs based on a MAC CE: DL TCI state #5, UL TCI state #6, DL TCI state #3 and UL TCI state #8. In 560, the UE 110 interprets the order of TCI states based on a value of the TCI state ID where the first TCI state is associated with a smallest TCI state ID and the second TCI state is associated with the second smallest TCI state ID. In 570, the UE 110 interprets the order of TCI states is based on the TCI state index of the MAC CE. The exemplary embodiments are described with regard to either of the ordering techniques shown above. However, the exemplary embodiments are not limited to these techniques and the UE 110 may index or number the indicated TCI states in any appropriate manner.

In some embodiments, the parameter b₀ may comprise one bit and be used for joint TCI mode for mTRP. In this example, the exemplary parameter b₀ may be defined in the following manner to indicate which one of the two joint TCI states is to be updated by the newly indicated TCI state. When b₀ is a first value (e.g., 0), this may indicate that the first joint TCI state is to be updated. When b₀ is a second value (e.g., 1), this may indicate that the second joint TCI state is to be updated. In some scenarios, b₀ may be reserved or undefined if two joint TCI states are indicated by the TCI field of the DCI are to be updated.

In another embodiment, parameter b₀b₁ may comprise two bits and be used for separate DL/UL unified TCI mode for mTRP.

In this example, the exemplary parameter b₀b₁ may be defined in the following manner to indicate which of the four possible TCI state combinations are to be updated by the newly indicated TCI state. b₀b₁ may be used to separately update DL and UL TCI states where b₀ is used for DL TCI states and b₁ is used for UL TCI states. When the bits of b₀b₁ are set to a first value (e.g., b₀=0, b₁=0), this may indicate that first DL TCI state and first UL TCI state are to be updated respectively. When the bits of b₀b₁ are set to a second value (e.g., b₀=1, b₁=1), this may indicate that second DL TCI state and second UL TCI state are to be updated respectively. It should be understood that during operation, b₀ and b₁ may be set to different value (e.g., b₀=0, b₁=1 or b₀=1, b₁=0.) In some scenarios, b₀ may be reserved or undefined if two DL TCI states are indicated by the TCI field of the DCI, b₁ may be reserved or undefined if two UL TCI states are indicated by the TCI field of the DCI or b₀b₁ may be reserved or undefined if four DL/UL TCI states are indicated by the TCI field of the DCI.

In some embodiments, b₀ may be used for a TCI state pair-based update. With this approach, the DL/UL TCI states are grouped into two pairs where pair 1 includes the first DL TCI state and the first UL TCI state and pair 2 includes the second DL TCI state and the second UL TCI state. The parameter b₀ may be used to indicate which pair is updated by the indicated TCI state. When b₀ is set to a first value (e.g., 0), this may indicate that pair 1 is to be updated. When b₀ is set to a second value (e.g., 1), this may indicate that pair 2 is to be updated. In some scenarios, b₀ may be reserved or undefined to update both pairs if two DL TCI states and/or two UL TCI states are indicated by the TCI field.

In a scenario where one or three TCI states are indicated by the TCI codepoint, the one bit b₀ may be applied to the DL or the UL TCI state that is associated with a single TCI state. For example, within the context of the table 500, when N=1 there is either a DL TCI state or an UL TCI state. When N=3, the UL TCI state may be updated for the combination of DL, UL, DL and the DL TCI state may be updated for the combination of DL, UL, UL. In other scenarios, the two TCI states with a same direction may be updated. For example, within the context of the table 500, when N=3, the DL TCI state may be updated for the combination of DL, UL, DL and the UL TCI state may be updated for the combination of DL, UL, UL.

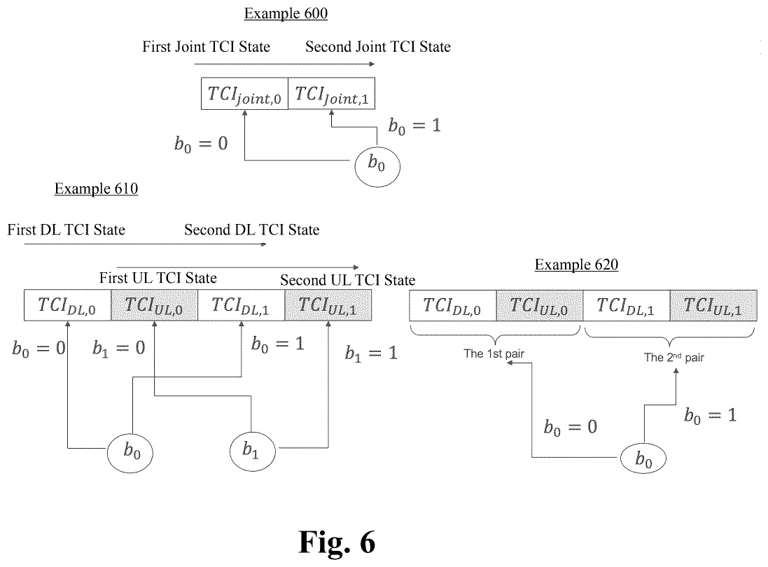

FIG. 6 shows examples 600-620 for using the exemplary parameters introduced herein to perform a TCI update according to various exemplary embodiments. Example 600 shows an example of using b₀ to perform a TCI state update for joint TCI mode. The joint TCI states are indexed using any of the exemplary techniques described above. In example 600, when b₀ is set to a value of 0 the first joint TCI state is to be updated and when b₀ is set to a value 1 the second joint TCI state is to be updated.

Example 610 shows an example of using b₀b₁ to perform a TCI state update for separate UL/DL TCI mode. The DL TCI states are indexed using any of the exemplary techniques described above. The UL TCI states are separately indexed in the same manner. In example 610, when b₀=0, b₁=0the first DL TCI state and the first UL TCI state are to be updated and when b₀=1, b₁=1 the second UL TCI state and DL TCI state are to be updated.

Example 620 shows an example of using b₀ to perform a pair-based TCI update for separate UL/DL TCI mode. A first UL TCI state and a first DL TCI state are grouped together to form a first pair. A second UL TCI state and a second DL TCI state are grouped together to form a second pair. In example 620, when b₀ is set to a value of 0 the first TCI pair is to be updated and when b₀ is set to a value of 1 the second TCI pair is to be updated.

In addition, the exemplary embodiments introduce techniques for providing the exemplary parameters b₀ and b₀b₁ to the UE 110. In one approach, a new TCI update indicator (TUI) field may be introduced for DCI that may be used to provide the parameters b₀ or b₀b₁. In another approach, the TUI information may be conveyed by selecting one from (M) predefined scrambling sequences to scramble the cyclic redundancy check (CRC) bits of the DCI format where M=2 for the one bit b₀ and M=4 for the two bit b₀b₁.

In another approach, the TUI information may be limited to DCI format 1_1 and DCI format 1_2 without data scheduling by repurposing the reserved bits. In other words, the reserved bits for DCI format 1_1 and/or DCI format 1_2 may be defined in a new manner and be used to indicate the exemplary parameters b₀ or b₀b₁.

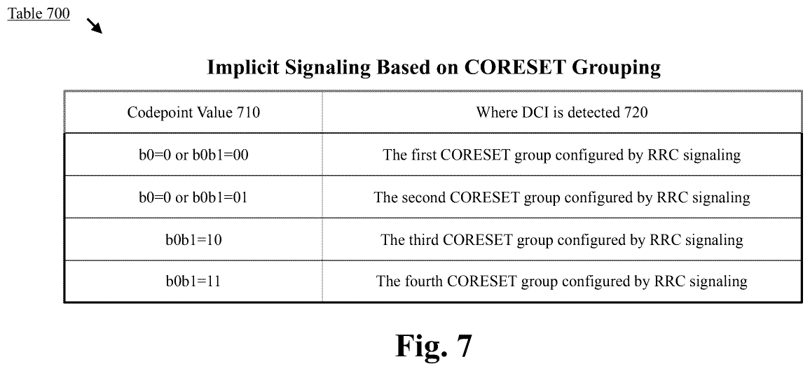

In another approach, CORESETs may be divided into (K) groups indexed from 0 to K-1 where K=2 for b₀ and K=4 for b₀b₁. Then the values of b₀ and b₀b₁ are determined depending on the CORESET group where the scheduling DCI is detected based on a predefined table an example of which is shown in FIG. 7. The predefined table may be hard encoded in 3GPP specification or predefined in any other appropriate manner.

FIG. 7 shows a table 700 for implicit signaling based on CORESET grouping according to various exemplary embodiments. The table 700 includes a column 710 showing TCI codepoint values and column 720 identifying which CORESET configured by RRC signaling contains the detected DCI.

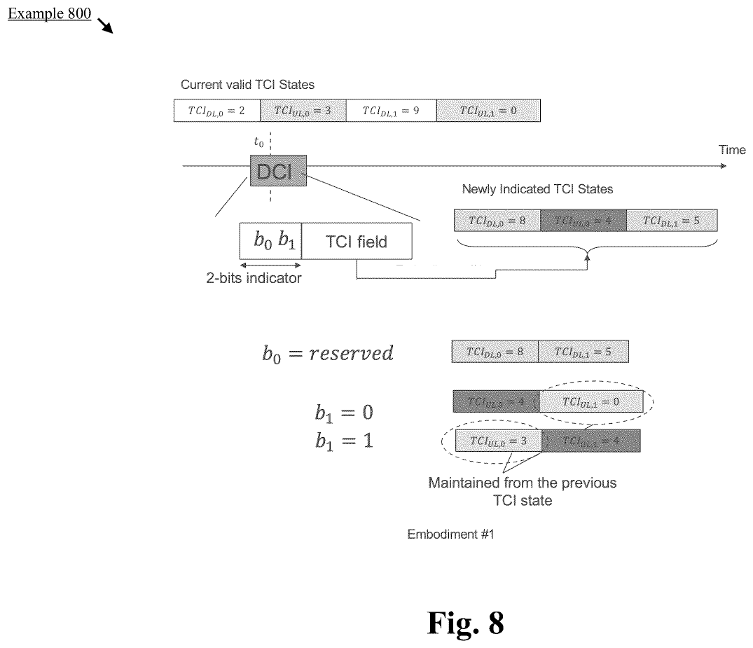

FIG. 8 shows an example 800 of performing a TCI state update for mTRP according to various exemplary embodiments. In example 800 it is assumed that there are four current valid TCI states at a first time (e.g., t₀) comprising DL TCI ID #2, UL TCI ID #3, DL TCI ID #9 and UL TCI ID #0.

In addition, in example 800, three unified TCI states are indicated by the DCI in the TCI field comprising DL TCI ID #8, UL TCI ID #4 and DL TCI ID #5. The parameter b₀b₁ is also provided in the DCI and may indicate which of the current valid TCI states are to be updated. In this example, the current valid TCI states are numbered in the order in which they are listed above, e.g., first DL TCI state is DL TCI ID #2, second DL TCI state ID is #9 and the first UL TCI state is UL TCI state ID #3 and UL TCI state ID #0.

In example 800, b₀ is reserved or undefined because there are two indicated DL TCI states. Thus, DL TCI ID #2 and DL TCI ID #9 are to be updated to the newly indicated DL TCI states DL TCI ID #8 and DL TCI ID #5.

When b₁ is set to 0, this may indicate that the first UL TCI state is to be updated. Therefore, UL TCI state ID #3 is updated to the newly indicated UL TCI state #4 and the second TCI state (e.g., TCI state ID #0) is maintained from the previous TCI state configuration. When b₁ is set to 1, this may indicate that the second UL TCI state is to be updated. Therefore, UL TCI state ID #0 is updated to the newly indicated UL TCI state #4 and the first TCI state (e.g., TCI state ID #3) is maintained from the previous TCI state configuration.

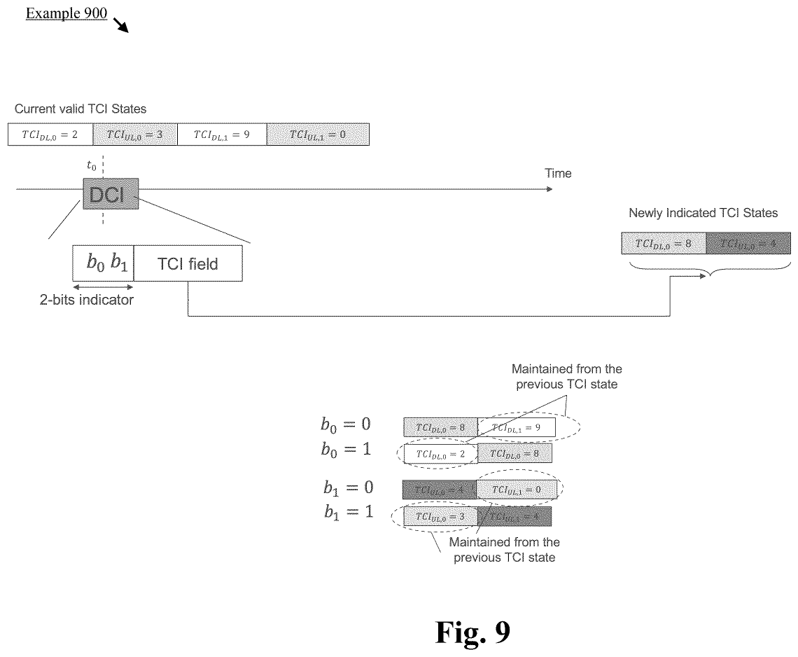

FIG. 9 shows an example 900 of performing a TCI state update for mTRP according to various exemplary embodiments. In example 900 it is assumed that there are four current valid TCI states at a first time (e.g., t₀) comprising DL TCI ID #2, UL TCI ID #3, DL TCI ID #9 and UL TCI ID #0. In this example, the current valid TCI states are numbered in the order in which they are listed above, e.g., first DL TCI state is DL TCI ID #2, second DL TCI state ID is #9 and the first UL TCI state is UL TCI state ID #3 and UL TCI state ID #0.

In addition, in example 900, two unified TCI states are indicated by the DCI in the TCI field comprising DL TCI ID #8 and UL TCI ID #4. The parameter b₀b₁ is also provided in the DCI and may indicate which of the current valid TCI states are to be updated.

When b₀ is set to 0, this may indicate that the first DL TCI state is to be updated. Therefore, DL TCI state ID #2 is updated to the newly indicated DL TCI state #8 and the second DL TCI state (e.g., DL TCI state #9) is maintained from the previous TCI state configuration. When b₀ is set to 1, this may indicate that the second DL TCI state is to be updated. Therefore, DL TCI state ID #9 is updated to the newly indicated DL TCI state #8 and the first DL TCI state (e.g., DL TCI state #2) is maintained from the previous TCI state configuration.

When b₁ is set to 0, this may indicate that the first UL TCI state is to be updated. Therefore, UL TCI state ID #3 is updated to the newly indicated UL TCI state #4 and the second UL TCI state (e.g., TCI state ID #0) is maintained from the previous TCI state configuration. When b₁ is set to 1, this may indicate that the second UL TCI state is to be updated. Therefore, UL TCI state ID #0 is updated to the newly indicated UL TCI state #4 and the first TCI state (e.g., TCI state ID #3) is maintained from the previous TCI state configuration.

According to some aspects, the exemplary embodiments introduce techniques for TCI state indication for CORSETs in sDCI mTRP mode. The following exemplary techniques may be used to provide a TCI state for a CORESET to apply the indicated TCI state for PDCCH reception.

The exemplary embodiments are described with regard to three different types of CORSETs, e.g., Type-A CORESET, Type-B CORSET and CORESET 0. The Type-A CORESET refers to a CORESET other than CORESET 0 which is associated with UE-specific search space (USS) and/or Type-3 common search space (CSS) on PDCCH in a CC. Type-B CORSET may refer to a CORESET other than CORESET 0 that is associated with at least a CSS other than Type-3 CSS.

Those skilled in the art will understand that CORSET 0 refers to a type of CORESET defined in 3GPP specification and the exemplary embodiments may utilize CORESET 0 in the manner in which it is defined in 3GPP specification and in accordance with the exemplary embodiments described herein.

The above-reference CORESETs may correspond to a CORESET-Type dependent TCI state indication. For Type-A CORESET, an indicator IE may be provided by RRC signaling as part of CORESET configuration to indicate one of the three candidate TCI states (e.g., the first TCI state, the second TCI state or both TCI states).

For Type-B CORSET, an indicator IE may be provided by RRC signaling as part of CORESET configuration to indicate one of the four candidate values (e.g., the first TCI state, the second TCI state, both TCI states or none of the TCI states). If the value of none is provided for a CORESET, a 3GPP Release 15 (Rel-15) /Rel-16 TCI indication framework and Rel-15/Rel-16 MAC CE may be used to provide on Rel-18 joint/DL TCI state for the CORESET from the TCI state list configured by RRC signaling.

For CORESET 0, an indicator IE may be provided by RRC signaling to indication one of the three candidate values (e.g., the first TCI state, the second TCI state, none).

In some embodiments, if one joint or downlink TCI state is indicated and applied, the following two options may be considered for CORESETs that are configured to follow the second TCI state. In a one option, the CORESET may be release or deactivated. Correspondingly, the UE 110 may not monitor PDCCH associated with the CORESET. In another option, the single TCI state is applied for the CORESET configured with the second TCI state.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments described above may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method comprising:
at a user equipment (UE):
establishing a connection to a base station in multi-transmission reception point (mTRP) mode, wherein the UE is configured with a first set of transmission configuration indicator (TCI) states to communicate with the base station;
receiving a TCI update, the TCI update indicating a second set of TCI states; and
updating the first set of TCI states based on the second set of TCI states indicated by the TCI state update.

2. The method of claim 1, wherein the TCI update further comprises a parameter indicating which one or more TCI states from the first set of TCI states are to be updated by the second set of TCI states.

3. The method of claim 2, wherein the first set of TCI states comprises a first joint TCI state and a second joint TCI state, and the second set of TCI states comprises a single joint TCI state and wherein the parameter comprises one bit, wherein,
when the one bit is set to a first value, the UE is configured to update the first joint TCI state using the single joint TCI state of the second set of TCI states, and
when the one bit it set to a second value, the UE is configured to update the second joint TCI state using the single joint TCI state of the second set of TCI states.

4. The method of claim 3, wherein, when two joint TCI states are indicated by the TCI update for the second set of TCI state, the one bit is reserved.

5. The method of claim 2, wherein the first set of TCI states comprises a first uplink (UL) TCI state, a second UL TCI state, a first downlink (DL) TCI state and a second DL TCI state and wherein the parameter comprises a first bit configured for UL TCI update indication and a second bit configured for DL TCI update indication.

6. The method of claim 5, wherein, when the first bit is set to a first value, the UE is configured to update the first UL TCI state using the second set of TCI states, and
when the second bit is set to a second value, the UE is configured to update the second UL TCI state using the second set of TCI states.

7. The method of claim 5, wherein, when two UL TCI states and two DL TCI states are indicated by the TCI state update for the second set of TCI states, the first bit and the second bit are reserved.

8. The method of claim 5, wherein, when the second bit is set to a first value, the UE is configured to update the first DL TCI state using the second set of TCI states, and
when the second bit is set to a second value, the UE is configured to update the second DL TCI state using the second set of TCI states.

9. The method of claim 2, wherein the first set of TCI states is grouped into a first pair comprising a first downlink (DL) TCI state and a first uplink (UL) TCI state and a second pair comprising a second DL TCI state and a second UL TCI state and wherein the parameter comprises one bit, wherein
when the one bit is set to a first value, the UE is configured to update the first pair using the second set of TCI states, and
when the one bit is set to a second value, the UE is configured to update the second pair using the second set of TCI state.

10. The method of claim 2, wherein the TCI update is downlink control information (DCI) and the parameter is provided in a TCI update indicator field.

11. The method of claim 2, wherein the TCI update is downlink control information (DCI) and the parameter is based on a predefined scrambling sequence used to scramble the cyclic redundancy check (CRC) bits of the DCI.

12. The method of claim 2, wherein the TCI update is downlink control information (DCI) format 1_1 or format 1_2 without data scheduling and the parameter is providing by repurposing the reserved bits in the DCI payload.

13. The method of claim 2, further comprising:
grouping, by radio resource control (RRC) signaling, the control resource ser (CORESET) into multiple CORESET groups; and
wherein the parameter is implicitly indicated based on the index of the CORESET group where the TCI state is detected.

14. The method of claim 1, wherein the first set of TCI states comprises a first number of TCI states and the second set of TCI states comprises a second number of TCI states,
wherein the second number of TCI states is less than the first number of TCI states.

15. The method of claim 1, further comprising:
receiving a control resource set (CORESET)-type dependent TCI state indication for a CORESET.

16. The method of claim 15, wherein the CORESET-type dependent TCI state indication is for a Type-A CORESET which is associated with a UE specific search space (USS) or a Type-3 common search space (CSS) on physical downlink control channel (PDCCH), and
wherein the CORESET-type dependent TCI state indication is provided in an indicator information element (IE) configured to indicate one of three candidate values comprising a first TCI state, a second TCI state and both TCI states.

17. The method of claim 15, wherein the CORSET-type dependent TCI state indication is for a Type-B CORESET which is associated with a common search space (CSS) that is not a Type-3 CSS, and
wherein the CORESET-type dependent TCI state indication is provided in an indicator information element (IE) configured to indicate one of four candidate values comprising a first TCI state, a second TCI state, both TCI states and none of the TCI states.

18. The method of claim 17, wherein, when the indicator IE indicates none of the TCI states, a medium access control (MAC) control element (CE) provides a joint or downlink (DL) TCI state for the CORESET from a TCI state list configured by radio resource control (RRC) signaling.

19. The method of claim 15, wherein the CORESET-type dependent TCI indication is for a CORESET 0, and
wherein the CORESET-type dependent TCI state indication is provided in an indicator information element (IE) configured to indication one of three candidate values comprising a first TCI state, a second TCI state and none of the TCI states.

20. The method of claim 1, wherein, when a single joint or downlink (DL) TCI state is indicated in the TCI state update, the UE is configured to release a control resource set (CORESET) configured to follow a second TCI state.

21. (canceled)
